(19) United States
(12) Patent Application Publication
(10) Pub. No.: US 2010/0028750 A1
(43) Pub. Date: Feb. 4, 2010

(54) GAS DIFFUSION LAYER WITH LOWER GAS DIFFUSIVITY

(75) Inventors: Chunxin Ji, Pennfield, NY (US); Christian Wieser, Mainz (DE); Mark Mathias, Pittsford, NY (US); Paul D. Nicotera, Honeoye Falls, NY (US)

Correspondence Address: Brooks Kushman P.C., 1000 Town Center, Twenty-Second Floor, Southfield, MI, 48075-1238, US

(73) Assignee: GM GLOBAL TECHNOLOGY OPERATIONS, INC., Detroit, MI (US)

(21) Appl. No.: 12/185,479

(22) Filed: Aug. 4, 2008

(51) Int. Cl. H01M 2/00

(52) U.S. Cl. 429/34

(57) ABSTRACT

A gas diffusion layer for use in fuel cells includes a gas permeable diffusion structure and a microporous layer. The microporous layer incorporates a plurality of particles of anisotropic shape, simultaneously reducing the porosity of the microporous layer and increasing the tortuosity for gas transporting through the microporous layer. The anisotropic particles in the microporous layer are present in a first amount such that the gas diffusion layer has an increased gas transport resistance.

### BACKGROUND OF THE INVENTION

1. Field of the Invention

In at least one embodiment, the present invention is related to gas diffusion layers with increased gas diffusion resistance for use in fuel cells.

2. Background Art

Fuel cells are used as an electrical power source in many applications. In particular, fuel cells are proposed for use in automobiles to replace internal combustion engines. In proton exchange membrane (“PEM”) type fuel cells, hydrogen (H2) is supplied as fuel to the anode of the fuel cell, and oxygen is supplied as the oxidant to the cathode. The oxygen can either be in pure form (O2) or air (a mixture of O2 and N2). PEM fuel cells typically have a membrane electrode assembly (“MEA”) in which a solid polymer membrane has an anode catalyst on one face, and a cathode catalyst on the opposite face. The MEA is sandwiched between a pair of porous gas diffusion layers (“GDL”), which in turn are sandwiched between a pair of non-porous, electrically conductive elements or plates. These plates function as current collectors for the anode and the cathode, and contain appropriate channels and openings formed therein for distributing the fuel cell's gaseous reactants over the surfaces of the respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

Gas diffusion layers play a multifunctional role in PEM fuel cells. For example, GDL act as diffusers for reactant gases traveling to the anode and the cathode layers, while transporting product water to the flow field. GDL also conducts electrons and transfers heat generated at the MEA to the coolant, and acts as a buffer layer between the soft MEA and the stiff bipolar plates. Among these functions, the water management capability of GDL is critical to enable the highest fuel cell performance. In other words, ideal GDL would be able to remove the excess product water from an electrode during wet operating conditions or at high current densities to avoid flooding, and also maintains a certain degree of membrane electrolyte hydration to obtain decent proton conductivity during dry operating conditions. The solid electrolyte membrane (such as Nafion®) used in PEM fuel cells needs to be hydrated in order to maintain a certain degree of hydration to provide good proton conductivity. Hydrocarbon based PEM, which are emerging as an alternative solid electrolyte for fuel cell applications, have the potential to be cheaper and more favorable (no fluorine release) compared to the fluoropolymer-based solid electrolyte membrane such as Nafion. The hydrocarbon-based solid electrolyte membranes developed to date need a higher degree of hydration in order to achieve decent proton conductivity.

For PEM fuel cells targeting automotive applications, a dryer steady state operating condition is favorable, which requires good water retention capability of the GDL to maintain a certain degree of membrane hydration. The fuel cells in automotive applications will also experience wet operating conditions during start up, shut down and in a subfreezing environment.

Accordingly, there exists a need for GDL that can retain some product water under dry operating conditions, and remove excess product water during wet operating conditions for optimal function of the fuel cell.

### SUMMARY OF THE INVENTION

The present invention overcomes one or more problems of the prior art by providing in at least one embodiment a gas diffusion layer that is useful in fuel cell applications. The gas diffusion layer of this embodiment is positionable between an electrode (anode and/or cathode) and a flow field in a fuel cell. The gas diffusion layer of this embodiment includes a gas permeable diffusion substrate, and microporous layer disposed over the gas permeable diffusion substrate. The microporous layer includes fine carbon powders, and a plurality of particles dispersed within the carbon powders. The plurality of particles impacts the gas transport resistance across the gas diffusion layer. The inclusion of particles within the microporous layer increases the gas tortuosity for gas, such as water vapor moving therein, thereby increasing the gas transport resistance. Accordingly, in a variation traditional carbon fiber paper is used as the gas permeable diffusion substrate thereby retaining the desired mechanical properties of such materials.

In another embodiment of the present invention, a fuel cell incorporating the diffusion layers of the invention is provided. In these fuel cells, the diffusion layer is positioned between the anode flow field and the anode layer and/or between the cathode flow field and the cathode layer.

### BRIEF DESCRIPTION OF THE DRAWINGS

FIG. 1 is a perspective view of a fuel cell incorporating the diffusion layer of an embodiment of the present invention;

FIG. 2 is a schematic cross-section of a variation of the gas diffusion layer of the present invention;

FIG. 3 is a table providing formulations for a control sample and a graphitic flake-containing test sample;

FIG. 4 provides plots of the voltage versus current density for cells incorporating these GDL's under wet conditions; and

FIG. 5 provides plots of the voltage versus current for cells incorporating these GDL's under dry conditions.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refer to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention, and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

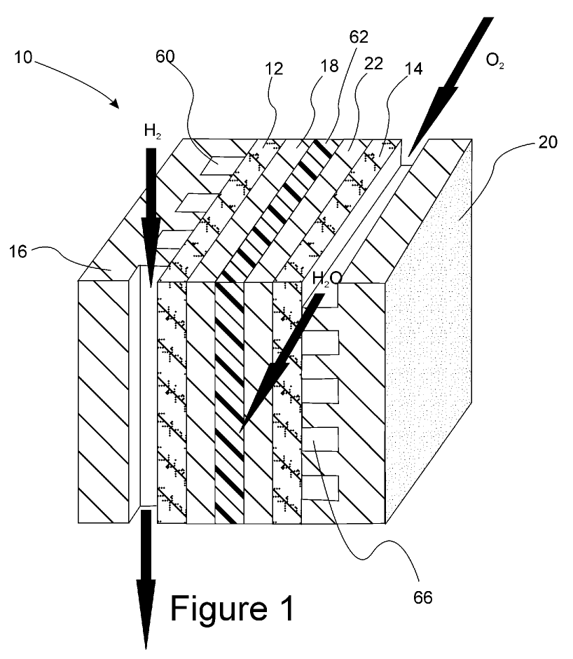

In at least one embodiment of the present invention, a diffusion layer positionable between an electrode and a flow field in a PEM fuel cell is provided. With reference to FIG. 1, a perspective view of a fuel cell incorporating the diffusion layer of the present embodiment is provided. PEM fuel cell 10 includes gas diffusion layers 12, 14. Gas diffusion layer 12 is positioned between anode flow field 16 and anode layer 18 while gas diffusion layer 14 is positioned between cathode flow field 20 and cathode layer 22.

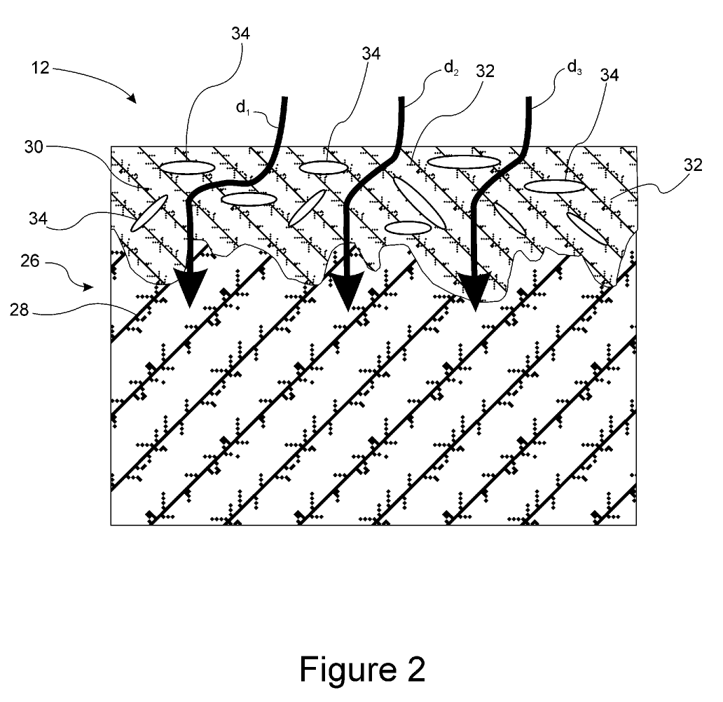

With reference to FIG. 2, a schematic cross-section of a variation of the gas diffusion layers of the present invention is provided. One or both of gas diffusion layers 12, 14 include gas permeable diffusion substrate 28 and microporous layer 30 disposed over the gas permeable diffusion substrate. In a variation of the present embodiment, a gas permeable diffusion substrate has a thickness from about 50 microns to 500 microns. The microporous layer has a thickness from 10 microns to 100 microns and may either form a discrete layer on the substrate or penetrate into a gas permeable substrate. Microporous layer 30 includes fine carbon powder section 32, and a plurality of particles 34 dispersed therein. Plurality of particles 34 reduces the available volume or cross-sectional area (i.e. reduces porosity) and increases distance traversed by gases moving through fine powder (i.e. increases tortuosity) section 32 as indicated by directions d₁, d₂, and d₃. These distances are increased since gases necessarily use non-linear paths to pass through microporous layer 30.

In a variation of the present embodiment, plurality of particles 34 is present in an amount such that the gas transport resistance is substantially increased when compared to the prior art. The gas transport resistance can be varied by both the amount of particles 34 in microporous layer 30 decreases the porosity (i.e., pore volume) of the gas diffusion layers and increases the tortuosity (i.e., the effective pore length) of these layers, both effects resulting in an increase in diffusive transport resistance.

Gas diffusion layer 12 typically includes in addition to a plurality of particles 34, a gas diffusion substrate 28 and a microporous layer 30 found in the usual prior art gas diffusion layers. For example, gas permeable diffusion substrate 28 may include an electrically conductive non-woven textile or paper or an electrically conductive woven textile or cloth. More specific examples for gas permeable diffusion substrate 28 include, but are not limited to, carbon fiber paper or a carbon-impregnated cloth. The gas transport resistance of Toray® TGP-H-060 carbon fiber paper, which is about 180 microns thick, is about 0.1 s/cm at 100 kPa and 80° C. as set forth in U.S. Pat. No. 7,157,178. The entire disclosure of this patent in hereby incorporated by reference.

In a variation of the present embodiment, microporous layer 30 includes a carbon powder and a fluorocarbon polymer binder. Examples of suitable fluorocarbon polymer binders include, but are not limited to, fluoropolymers, such as polytetrafluorethylene (“PTFE”), fluorinatedethylenepropylene (“FEP”), and combinations thereof.

As set forth above, microporous layer 30 includes a plurality of dispersed particles. Typically, at least a portion of the plurality of particles comprise three-dimensional objects having a plate-like shape. In one variation of the present embodiment, at least a portion of the plurality of particles comprise electrically conductive flakes. In a further refinement of this variation, the electrically conductive flakes have a largest dimension from about 0.1 micron to about 50 microns. In another refinement of this embodiment, the electrically conductive flakes have a smallest dimension from about 1 micron to about 5 microns. In still another refinement of the present embodiment, the electrically conductive flakes have a largest dimension from about 5 micron to about 15 microns. Examples of useable conductive flakes include, but are not limited to, graphite flakes.

With reference to FIGS. 1 and 2, a fuel cell that incorporates the diffusion layers of the invention set forth above is provided. Fuel cell 10 of this embodiment includes anode gas flow field 16, which typically includes one or more channels 60 for introducing a first gas to the fuel cell 10. Anode diffusion layer 12 is disposed over anode gas flow field 16 while anode catalyst layer 18 is disposed over the anode diffusion layer 12. Polymeric ion conductive membrane 62 is disposed over anode catalyst layer 18. Cathode layer 22 is disposed over polymeric ion conductive membrane 62. Cathode diffusion layer 14 is disposed over cathode layer 22. Finally, cathode gas flow field 20 is disposed over cathode diffusion layer 14. Cathode gas flow field 20 includes one or more channels 66 for introducing a second gas into fuel cell 10. At least one of the anode diffusion layer 12 or the cathode diffusion layer 14 comprises a gas permeable diffusion structure 26 and microporous layer 30. As set forth above, microporous layer 30 is disposed over the gas permeable diffusion substrate with a plurality of particles 34 dispersed therein. The details of gas diffusion substrate 28, microporous layer 30, and plurality of particles 34 are the same as those set forth above.

The following examples illustrate the various embodiments of the present invention. Those skilled in the art will recognize many variations that are within the spirit of the present invention and scope of the claims.

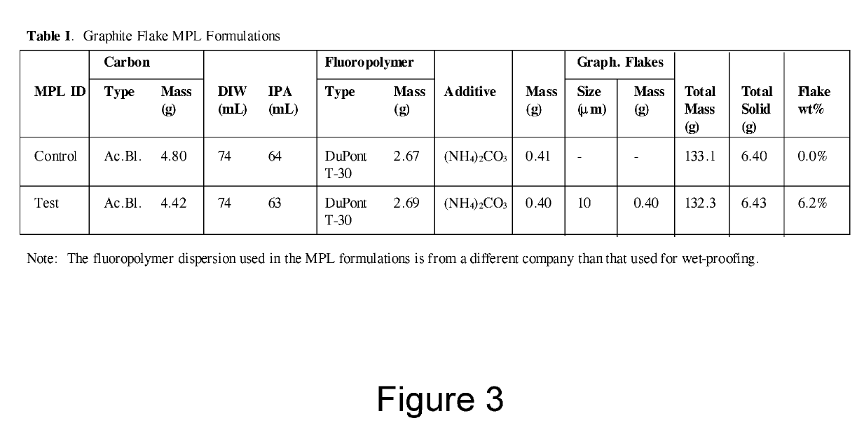

A control sample and a graphitic flake-containing test sample are prepared as follows (see Table I in FIG. 3). Graphite flakes with a median size of 7 to 10 μm are purchased from VWR International. In accordance with the one-step sintering process as described in U.S. Pat. No. 7,063,913 B2, a Toray TGP-H-060 carbon paper substrate is first dipped in 3% diluted Daikin D2C dispersion and then dried under an IR lamp at about 64° C. to form a hydrophobic Toray substrate. The PTFE uptake is measured to be about 12.9 wt %. A microporous layer with 68.7% acetylene black, 25.1% PTFE binder, and 6.2% graphite flakes are coated on the hydrophobic Toray substrate, and then sintered at about 380° C. for 20 mins. The control sample which does not contain graphite flakes in the microporous layer (75% acetylene black and 25% PTFE) is prepared in an analogous manner. Both of the final coatings had a measured loading of 1 mg/cm².

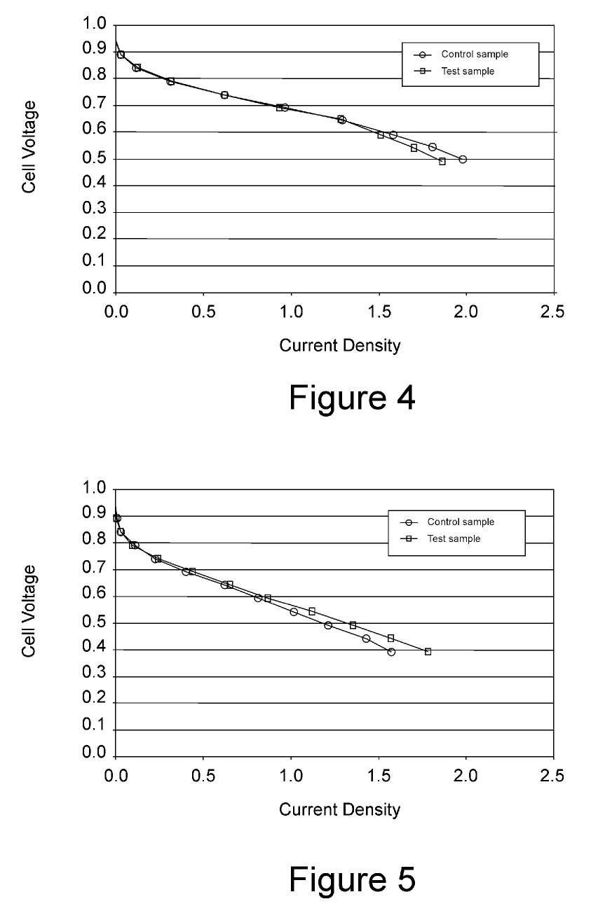

The performance of a GDL with and without graphite flakes in the MPL under both wet and dry operating conditions is evaluated as shown in FIGS. 4 and 5. FIG. 4 provides plots of the voltage versus current density for hydrogen-air fuel cells incorporating these GDL's under wet conditions. FIG. 5 provides plots of the voltage versus current density for cells incorporating these GDL's under dry conditions. Under wet operating conditions, the performance of a test sample that includes graphite flakes is slightly worse than a control sample that does not include graphite flakes at 2 A/cm². However, the performance of both cells is close up to currents of about 1.5 A/cm². Under the dryer operating condition, the performance of a test sample that includes graphite flakes is better than the control sample. For the wet test condition, the anode and cathode gas pressure and relative humidity are 270 kPa-abs and 100% at the inlets, and the cell temperature is 60° C. For the dry test condition, the gas pressure and relative humidity are 101 kPa-abs and 40% at the inlets, and the cell temperature is 70° C. For both test conditions, the reactant stoichiometries for H₂ and O₂ were kept at 2.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A gas diffusion layer for use in a fuel cell comprise a flow field, an ion conducting membrane, and an electrode, the gas diffusion layer comprising:
a gas permeable diffusion substrate; and
a microporous layer disposed over the gas permeable diffusion substrate, the microporous layer comprising carbon powders and a plurality of particles dispersed therein, the presence of the plurality of particles varying the gas transport resistance across the microporous layer, the diffusion layer positionable between the electrode and the flow field.

2. The diffusion layer of claim 1 wherein the gas transport resistance is increased due to the presence of the plurality of particles.

3. The diffusion layer of claim 1 wherein the gas permeable diffusion substrate comprises an electrical conductive non-woven textile or paper or a woven textile or cloth.

4. The diffusion layer of claim 1 wherein the gas permeable diffusion substrate has a thickness from about 50 microns to 500 microns.

5. The diffusion layer of claim 1 wherein the gas permeable diffusion substrate comprises carbon fiber paper or a carbon impregnated cloth.

6. The diffusion layer of claim 1 wherein the microporous layer comprises a carbon powder and a fluorocarbon polymer binder.

7. The diffusion layer of claim 6 wherein the fluorocarbon polymer binder comprises a component selected from the group consisting of polytetrafluorethylene, fluorinatedethylenepropylene, and combinations thereof.

8. The diffusion layer of claim 1 wherein at least a portion of the plurality of particles comprise three-dimensional objects having a plate-like shape with certain aspect ratios.

9. The diffusion layer of claim 1 wherein at least a portion of the plurality of particles comprise electrically conductive flakes.

10. The diffusion layer of claim 9 wherein the electrically conductive flakes comprise graphite flakes.

11. The cathode diffusion layer of claim 9 wherein the electrically conductive flakes have a largest dimension from about 0.1 microns to about 50 microns.

12. The cathode diffusion layer of claim 9 wherein the electrically conductive flakes have a smallest dimension from about 1 micron to about 5 microns.

13. The cathode diffusion layer of claim 9 wherein the electrically conductive flakes have a largest dimension from about 5 microns to about 15 microns.

14. A fuel cell comprising:
an anode gas flow field having one or more channels for introducing a first gas to the fuel cell,
an anode diffusion layer disposed over the anode gas flow field;
an anode electrode layer disposed over the anode diffusion layer;
a polymeric ion conductive membrane disposed over the anode electrode layer;
a cathode electrode layer disposed over the polymeric ion conductive membrane;
a cathode diffusion layer disposed over the cathode electrode layer;
a cathode gas flow field having one or more cathode plate channels for introducing a second gas to the fuel cell, the cathode flow field being disposed over the cathode diffusion layer, wherein at least one of the anode diffusion layer or the cathode diffusion layer comprises:
a gas permeable diffusion substrate; and
a microporous layer disposed over the gas permeable diffusion substrate, the microporous layer having a plurality of particles dispersed therein, the plurality of particles increasing the gas transport resistance across the gas diffusion layer.

15. The fuel cell of claim 14 wherein the gas permeable diffusion substrate comprises a non-woven textile or paper or a woven textile or cloth.

16. The fuel cell of claim 14 wherein the gas permeable diffusion substrate has a thickness from about 50 microns to 500 microns.

17. The fuel cell of claim 14 wherein the microporous layer comprises a carbon powder and a fluorocarbon polymer binder.

18. The fuel cell of claim 14 wherein the fluorocarbon polymer binder comprises a component selected from the group consisting of polytetrafluorethylene, fluorinatedethylenepropylene and combinations thereof.

19. The fuel cell of claim 14 wherein at least a portion of the plurality of particles comprise three-dimensional objects having a plate-like shape.

20. The fuel cell of claim 14 wherein at least a portion of the plurality of particles comprise electrically conductive flakes.

21. The fuel cell of claim 20 wherein the electrically conductive flakes comprise graphite flakes.

22. The fuel cell of claim 20 wherein the electrically conductive flakes have a largest dimension from about 0.1 micron to about 50 microns.

23. The fuel cell of claim 20 wherein the electrically conductive flakes have a smallest dimension from about 1 micron to about 5 microns.

24. The fuel cell of claim 20 wherein the electrically conductive flakes have a largest dimension from about 5 microns to about 15 microns.

25. A fuel cell comprising:
an anode gas flow field having one or more channels for introducing a first gas to the fuel cell,
an anode diffusion layer disposed over the anode gas flow field;
an anode electrode layer disposed over the anode diffusion layer;
a polymeric ion conductive membrane disposed over the anode electrode layer;
a cathode electrode layer disposed over the polymeric ion conductive membrane;
a cathode diffusion layer disposed over the cathode electrode layer;
a cathode gas flow field having one or more cathode plate channels for introducing a second gas to the fuel cell, the cathode flow field being disposed over the cathode diffusion layer, wherein the anode diffusion layer and the cathode diffusion layer each independently comprise:
a gas permeable diffusion substrate; and
a microporous layer disposed over the gas permeable diffusion substrate, the microporous layer having a plurality of particles dispersed therein, the plurality of particles increasing the gas transport resistance across the gas diffusion layer.
